(19) United States
(12) Patent Application Publication
(10) Pub. No.: US 2014/0057619 A1
(43) Pub. Date: Feb. 27, 2014

(54) SYSTEM AND METHOD FOR ADJUSTING OPERATION MODES OF A MOBILE DEVICE

(71) Applicant: Tencent Technology (Shenzhen) Company Limited, Shenzhen (CN)

(72) Inventor: Qiang CHEN, Shenzhen (CN)

(73) Assignee: Tencent Technology (Shenzhen) Company Limited, Shenzhen (CN)

(21) Appl. No.: 14/063,872

(22) Filed: Oct. 25, 2013

Related U.S. Application Data
(63) Continuation of application No. PCT/CN2013/082174, filed on Aug. 23, 2013.

(30) Foreign Application Priority Data
Aug. 24, 2012 (CN) 201210305360.3

(51) Int. Cl. H04W 24/02

(52) U.S. Cl. CPC H04W 24/02
USPC 455/418

(57) ABSTRACT

A computer-implemented method is performed by a mobile device for automatically activating a particular operation mode. The method includes: dividing a predefined time window into multiple time segments for the mobile device based on a user's schedule; for each time segment, defining an operation mode and associated information for the mobile device, wherein the associated information includes a set of instructions for processing incoming calls or messages during the time segment; and upon detection of the start of a particular time segment: identifying a corresponding operation mode; and activating the identified operation mode on the mobile device such that, in response to an incoming call or message, the mobile device performs a set of instructions associated with the operation mode.

### RELATED APPLICATIONS

This application is a continuation application of PCT Patent Application No. PCT/CN2013/082174, entitled “SYSTEM AND METHOD FOR ADJUSTING OPERATION MODES OF A MOBILE DEVICE” filed on Aug. 23, 2013, which claims priority to Chinese Patent Application No. 201210305360.3, “SYSTEM AND METHOD FOR ADJUSTING OPERATION MODES OF A MOBILE DEVICE,” filed on Aug. 24, 2012, both of which are hereby incorporated by reference in their entirety.

### FIELD OF THE INVENTION

The present invention generally relates to wireless communication using mobile devices, in particular to system and method for automatically adjusting the operation mode of a mobile device based on a set of predefined conditions.

### BACKGROUND OF THE INVENTION

With the development of wireless communication technology, mobile devices such as cellular phones (especially smartphones) are playing more important roles in people's life. In order to better serve a user, a mobile device provides operation modes designed for different usage scenarios. For example, a mobile device usually has a standard operation mode, a silent operation mode, a meeting operation mode, an outdoor operation mode, etc. Each operation mode has its own phone call or message alert ringtone. Additionally, an operation mode may have a set of instructions for establishing network connections, blocking unwelcomed messages, configuring the usage of alarm clocks. Currently, a user often manually chooses an operation mode for his/her mobile device based on the surrounding environment as well as the user's specific needs. For example, when the user is going to attend a conference, he/she may activate the silent or meeting operation mode so as to prevent the mobile from producing any ringtone during the conference. But after the conference is over, the user has to remember to manually switch the mobile device back to the standard operation mode. If the user fails to do so, he/she may miss incoming calls or messages. This process is not only tedious but also time consuming.

### SUMMARY

The above deficiencies and other problems associated with the current practice of mobile device configuration are reduced or eliminated by the invention disclosed below. In some embodiments, the invention is implemented in a mobile device that has one or more processors, memory and one or more modules, programs or sets of instructions stored in the memory for performing multiple functions. Instructions for performing these functions may be included in a computer program product configured for execution by one or more processors of a mobile device.

One aspect of the invention involves a computer-implemented method performed by a mobile device for automatically activating a particular operation mode designed for a specific usage scenario with little or no user intervention. The method includes: dividing a predefined time window into multiple time segments for the mobile device based on a user's schedule; for each time segment, defining an operation mode and associated information for the mobile device, wherein the associated information includes a set of instructions for processing incoming calls or messages during the time segment; and upon detection of the start of a particular time segment: identifying a corresponding operation mode; and activating the identified operation mode on the mobile device such that, in response to an incoming call or message, the mobile device performs a set of instructions associated with the operation mode.

Another aspect of the invention involves a mobile device. The mobile device includes one or more processors, memory, and one or more program modules stored in the memory and configured for execution by the one or more processors. The one or more program modules include instructions for: dividing a predefined time window into multiple time segments for the mobile device based on a user's schedule; for each time segment, defining an operation mode and associated information for the mobile device, wherein the associated information includes a set of instructions for processing incoming calls or messages during the time segment; and upon detection of the start of a particular time segment: identifying a corresponding operation mode; and activating the identified operation mode on the mobile device such that, in response to an incoming call or message, the mobile device performs a set of instructions associated with the operation mode.

Another aspect of the invention involves a non-transitory computer readable storage medium having stored therein instructions, which, when executed by a mobile device, cause the mobile device to: divide a predefined time window into multiple time segments for the mobile device based on a user's schedule; for each time segment, define an operation mode and associated information for the mobile device, wherein the associated information includes a set of instructions for processing incoming calls or messages during the time segment; and upon detection of the start of a particular time segment: identify a corresponding operation mode; and activate the identified operation mode on the mobile device such that, in response to an incoming call or message, the mobile device performs a set of instructions associated with the operation mode.

Some embodiments may be implemented on either the client side or the server side of a client-server network environment.

### BRIEF DESCRIPTION OF THE DRAWINGS

The aforementioned features and advantages of the invention as well as additional features and advantages thereof will be more clearly understood hereinafter as a result of a detailed description of preferred embodiments when taken in conjunction with the drawings.

FIG. 1 is a flowchart illustrative of a first embodiment of configuring the operation modes for a mobile device.

FIG. 2 is a flowchart illustrative of a second embodiment of configuring the operation modes for a mobile device.

FIGS. 3-5 are block diagrams illustrative of a third embodiment of program modules in a mobile device for configuring the operation modes for the mobile device.

FIG. 6 is a block diagram of an exemplary mobile device in accordance with some embodiments.

Like reference numerals refer to corresponding parts throughout the several views of the drawings.

### DESCRIPTION OF EMBODIMENTS

Reference will now be made in detail to embodiments, examples of which are illustrated in the accompanying drawings. In the following detailed description, numerous specific details are set forth in order to provide a thorough understanding of the subject matter presented herein. But it will be apparent to one skilled in the art that the subject matter may be practiced without these specific details. In other instances, well-known methods, procedures, components, and circuits have not been described in detail so as not to unnecessarily obscure aspects of the embodiments.

As noted above, the conventional approach of choosing an appropriate operation mode for a mobile device requires a lot of user intervention. Therefore, an important aspect of the present invention is to reduce the amount of user intervention and configure the mobile device such that it can intelligently select and activate an operation mode based on predefined conditions and the real-time environment surrounding the mobile device.

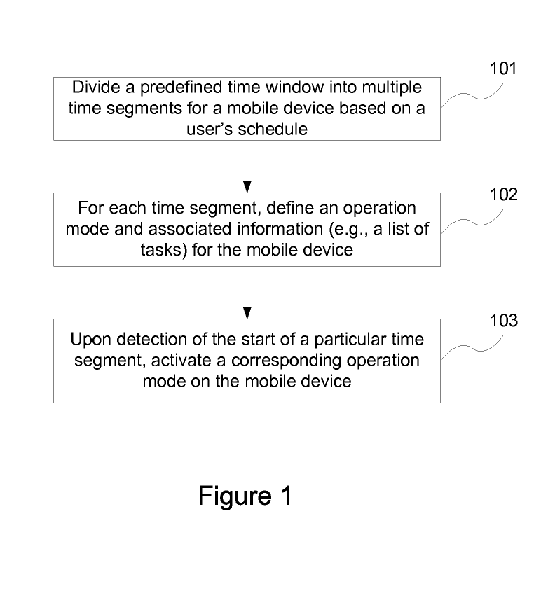

FIG. 1 is a flowchart illustrative of a first embodiment of configuring the operation modes for a mobile device. If a user routinely performs different predefined functions, it is possible for the mobile device used by the user to activate a predefined operation mode that is customized for a specific environment in which the user is performing a specific function. For example, if the user has a daily group meeting from 9:00 AM to 10:00 AM every day of the week, the mobile device can be configured to automatically enter the meeting operation mode at 9:00 AM and leave the meeting operation mode at 10:00 AM without any further user intervention.

At step 101, the mobile device divides a predefined time window into multiple (N) time segments based on a user schedule. Note that the time window may be as short as half a day or as long as a whole week. This parameter can be customized by the user. For example, assuming that the time window is 24 hours (0:00-24:00) of a typical work day, the 24 hours may be roughly divided into at least three types of time segments, i.e., work segment, break segment, and private segment. The work segment may be further divided into an early morning session (e.g., 9:00 AM-10:00 AM), a late morning session (e.g., 10:00 AM-12:00 PM), and an afternoon session (e.g., 14:00 PM-17:00 PM). The break segment may include an after-lunch short break session between 13:00 PM and 14:00 PM (during which the user may have a short nap) and a night-long break session from 22:00 PM to 7:00 AM when the user is sleeping. The private segment may include a breakfast and morning commute session from 7:00 AM to 9:00 AM, a lunch break session from 12:00 PM to 13:00 PM, and an after-work commute and evening session from 18:00 PM to 22:00 PM. It should be noted that the time segments described above are for illustrative purpose and the mobile device may provide a graphical user interface for the user to create new time segments and update existing time segments such that there is a match between different activities of the user's daily schedule and the corresponding time segments.

At step 102, the mobile device defines an operation mode and information associated with the operation mode for each time segment. The associated information includes a set of instructions on how the mobile device operates its functions accordingly. Using the same example, a work operation mode is defined for the work segment. When the mobile device enters the work operation mode, it is configured to choose a WLAN connection (such as Wi-Fi) over a wireless cellular network connection (such as 3G or 4G) because the WLAN connection is more cost-effective. The mobile device may use vibration for alerting the arrival of an incoming call or message. This is particularly important if the incoming call or message arrives when the user is in a daily group meeting. By turning off the ringtone, the user can reduce the chance of disturbing other participants of the group meeting.

In some embodiments, the mobile device includes a whitelist of contacts and a blacklist of contacts. Except under special circumstances (which may be designated by the mobile device), the mobile device does not block incoming calls or messages from the whitelist of contacts. In contrast, the mobile device usually blocks incoming calls or messages from the blacklist of contacts. Besides the two lists, the mobile device may specify one or more triggering conditions for handling incoming calls or messages from those contacts that are not found in either list. For example, when the mobile device is in the work operation mode, it is configured to block only incoming calls or messages from the blacklist of contacts but let calls or messages from anybody else go through because at least some of them may be work-related. For example, if the user of the mobile device is a sales person, he or she should expect calls or messages from unknowns during his or her work hours. On the other hand, if the user of the mobile device is an engineer who is focusing on developing a new product, he or she may choose to specify that only incoming calls or messages from the whitelist of contacts be allowed to reduce the interruption to his or her work. A scenario between these two cases is that the mobile device may specify that the incoming call be blocked if it lasts less than a predefined time period (e.g., five seconds) or no more than one or two ringtones. For example, after receiving a call from an unknown, the mobile device may not vibrate or generate a ringtone for the first five seconds and only do so if the caller does not hang up after five seconds. This is another way to reduce the interruption caused by mis-dials by the caller. Note that both the two lists of the triggering conditions may be part of the information associated with the operation mode described above. In some embodiments, the mobile device also has a graylist of contacts whose privilege is between the whitelist and the blacklist. For example, an incoming call from a member in the graylist of contacts only triggers the vibration of the mobile device but it does not generate ringtones.

Other types of operation modes include a break operation mode that corresponds to the break segment and a private operation mode corresponding to the private segment. For example, during the break operation mode, the mobile device may be configured to allow incoming calls from the whitelist of contacts (who are often family members or close friends) to go through because the user of the mobile device may have a short nap or sleep at night. Incoming calls from unknowns are blocked but can be found in the call history. Similarly, incoming messages from the unknowns are stored in the memory of the mobile device without generating any alerts to the user. But for incoming calls or messages from the whitelist of contacts, the mobile phone is configured to generate ringtones or vibration or both because the communications from the whitelist of contacts are deemed important by the user and should not be missed. The user can control the members in the whitelist of contacts by moving contacts into or out of the whitelist based on his or her relationship with the contacts. Similarly, during the private operation mode, the mobile device is configured to set up the triggering conditions such that only incoming calls or messages that satisfy certain conditions may be allowed to go through. For example, a triggering condition is that incoming calls or messages from a person that the user has communicated with during, e.g., the last 30 days will be brought to the user's attention. By doing so, it is less likely that the user's private life may be disrupted by unwelcomed communications. In some other embodiments, the mobile device's battery power level may be used for determining whether an incoming call should go through and, if so, how the user should be alerted. For example, if the current battery power level is lower than a predefined threshold (e.g., 15%) and the mobile device is not being recharged, the mobile device may block some incoming phone calls or messages. Alternatively, the mobile device may allow the incoming calls or messages without generating any alerts to reduce the further power consumption. Of course, this might mean a missed incoming call or message. But when the battery power level is above the predefined threshold, the mobile device may then generate an alert indicating their presence so that the user can take necessary actions accordingly.

At step 103, upon detection of the start of a particular time segment, the mobile device activates a corresponding operation mode on the mobile device. In other words, the mobile device regularly checks the clock and compares the current time with the predefined time segments to determine whether or not the mobile device should enter a new operation mode. In some embodiments, the mobile device generates an alert message on its display whenever it departs from one operation mode and enters another operation mode. For example, if the mobile device departs from the private operation mode (during the time segment from 7:00 AM to 9:00 AM) and enters the work operation mode (during the time segment from 9:00 AM to 12:00 PM), the mobile device may generate a pop-up window and produce one or more audio or visual signals to alert the user of the mode transition. The pop-up window may disappear after a moment (e.g., a few seconds) or stay until the user clicks a key to acknowledge its presence. In contrast, when the mobile device departs from the work operation mode (during the time segment from 9:00 AM to 12:00 PM) to the break operation mode (during the time segment from 12:00 PM to 13:00 PM), the mobile device may only generate a pop-up window without producing any audio or visual because the mobile device may not be certain that such alert signals are welcomed or not.

Note that the description above focuses on the scenario that the user has a regular work schedule and the operation mode at any time during a day or night is quite predictable. But it is quite often that such regular schedule may be interrupted by other events. For example, the user may schedule a doctor appointment during a work time segment or a job interview during a lunch break time segment. Therefore, it is quite useful that the configuration of operation modes during different time segments may be modified by other criteria. In some embodiments, the mobile device queries a calendar application to determine whether the user has an appointment overlapping with a particular time segment. Note that this query may occur regularly or when some triggering conditions are met. For example, whenever the user generates a new appointment for a particular time period, the mobile device checks which time segment or segments this appointment overlaps with. For example, an appointment may happen entirely within one time segment that has a predefined operation mode or overlap with two or more time segments that have the same or different operation modes. In either case, the mobile device determines whether the appointment is consistent with the operation mode associated with the time segment or segments. For example, if the overlapping time segment is a work time segment but the appointment is a job interview, the mobile device should not generate any alert signals during the job interview but only generate records for incoming calls or messages and then alert the user of their presence subsequently after the job interview. In some embodiments, the mobile device may search the description of the appointment for certain keywords, such as “interview,” “medical,” “dental,” “meeting,” etc., to determine the nature of the appointment. In some other embodiments, the mobile device may check whether there is an invitee to an appointment such that it will not block incoming calls or messages from the invitee during the appointment because the appointment may be a conference call with the invitee. In some other embodiments, the mobile device also checks whether there is an existing appointment in the calendar application during the next time segment before activating the operation mode associated with the next time segment. If so, the mobile device checks whether the appointment is consistent with the next time segment using the approaches as described above and then updates the set of instructions associated with the operation mode based on a determination of the appointment. For example, if the appointment is a dinner appointment during the dinner time segment, the mobile device may increase the volume of the audio alert signals in case that the dinner appointment occurs in a noisy environment.

In some other embodiments, the current location of the mobile device may be used for determining how the mobile device should generate alert signals for incoming calls or messages from either a whitelist of contacts or persons that satisfy the predefined triggering conditions. To do so, the mobile device, regularly or in response to a triggering condition, queries a location application (e.g., a GPS module in the mobile device) to determine a current location of the mobile device. For example, if the mobile device is currently in the work operation mode and the location application indicates that the mobile device is located in a park, the mobile device may, at least partially, overwrite the set of instructions associated with the work operation mode that does not allow the generation of audio or visual alert signals because it would be difficult for the user to notice the incoming calls or messages and act promptly without such alert signals.

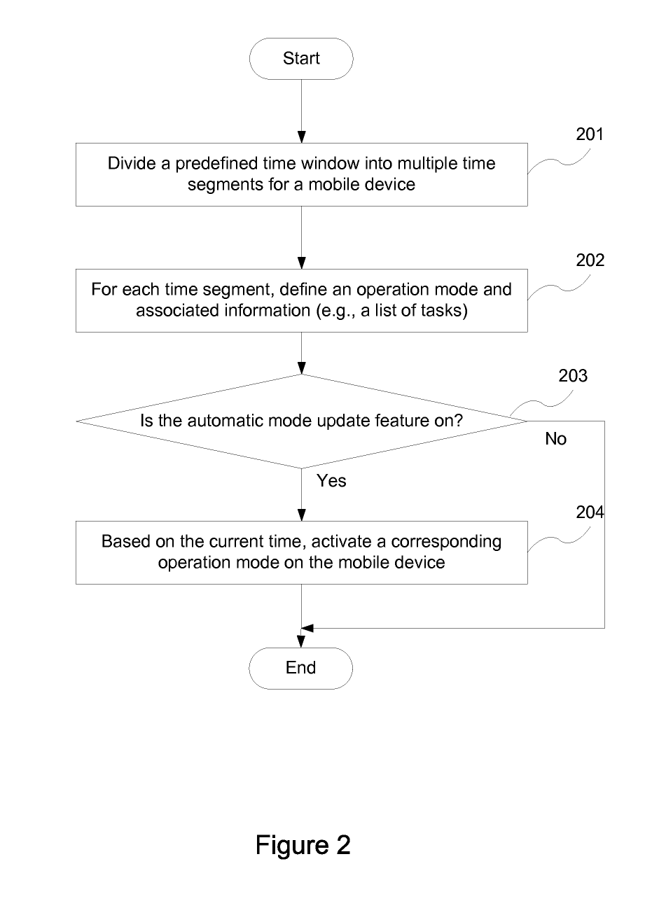

FIG. 2 is a flowchart illustrative of a second embodiment of configuring the operation modes for a mobile device. At step 201, the mobile device divides a predefined time window into multiple time segments for the mobile device. As noted above, the division of the time window into multiple time segments is based on the user's schedule and customizable when there is any change to the schedule. At step 202, the mobile device defines an operation mode and associated information. The associated information includes instructions on many aspects of the mobile device such as whose phone calls or message should go through or be blocked, what triggering conditions are used for screening incoming calls or messages, whether there is a ringtone for an incoming call or message that has been allowed, how an alert is presented to the user of the mobile device, etc. For illustrative purposes, a table 1 is provided that includes a set of sample time segments and their operation modes and the associated information:

| | | Information Associated the |
|---|---|---|
| Time Segment | Operation Mode | Operation Mode |
| Breakfast and morning | Break operation mode | Screen incoming calls or |
| commute session (7:00-9:00) | | messages based on |
| | | predefined conditions and |
| | | generate ringtone for allowed |
| | | calls or messages |
| Morning group meeting | Work operation mode | Block incoming calls or |
| session (9:00-10:00) | | messages from the blacklist |
| | | of contacts and generate |
| | | vibration for allowed calls or |
| | | messages |
| Morning work session | Work operation mode | Block incoming calls or |
| (10:00-12:00) | | messages from the blacklist |
| | | of contacts and generate |
| | | vibration for allowed calls or |
| | | messages |
| Lunch break session (12:00-13:00) | Break operation mode | Screen incoming calls or |
| | | messages based on |
| | | predefined conditions and |
| | | generate ringtone for allowed |
| | | calls or messages |
| After-lunch break session | Private operation mode | Allow incoming calls or |
| (13:00-14:00) | | messages from the whitelist |
| | | of contacts only and generate |
| | | ringtone for allowed calls or |
| | | messages |
| Afternoon work session | Work operation mode | Block incoming calls or |
| (14:00-18:00) | | messages from the blacklist |
| | | of contacts and generate |
| | | vibration for allowed calls or |
| | | messages |
| After-work commute and | Break operation mode | Screen incoming calls or |
| evening session (18:00-22:00) | | messages based on |
| | | predefined conditions and |
| | | generate ringtone for allowed |
| | | calls or messages |
| Night-long break session | Private operation mode | Allow incoming calls or |
| | | messages from the whitelist |
| | | of contacts only and generate |
| | | ringtone for allowed calls or |
| | | messages |

As noted above, both the whitelist and blacklist of contacts are customizable by the user of the mobile device. The predefined conditions include blocking commercial messages (e.g., a message from a list of phone numbers that are deemed to be providing only commercial messages). In some embodiments, information associated with different operation modes includes instruction on how to configure the mobile device's network connection. For example, the mobile device is configured to choose Wi-Fi connection over the wireless cellular network connection whenever it is available to avoid the expensive data usage through the wireless cellular network. In some other embodiments, the mobile device is configured to only choose the Wi-Fi connection if the Wi-Fi connection is from a reliable source (e.g., a secured source that requires username and password for establishing a connection). Like the whitelist of contacts, the user may establish a whitelist of secured Wi-Fi sources such that the mobile device would rather use the wireless cellular network connection if the available Wi-Fi connection is not found in the whitelist of secured Wi-Fi connections.

At step 203, the mobile device determines whether the automatic mode update feature on or not. In some embodiments, the user can turn off the automatic mode update feature described in the present application if the user is going to have a peculiar schedule that is quite different from his or her normal schedule. In this case, the user may choose to turn off this feature to avoid any unintended consequence. In some other embodiments, the automatic mode update feature is turned on when certain conditions are met. For example, whenever the mobile device is rebooted, the mobile device turns on this feature. Alternatively, the automatic mode update feature may be turned on whenever a new day, week, or month starts. It should be noted that the turn-on conditions are customizable by the user of the mobile device.

At step 204, the mobile device checks the current time and then activates a corresponding operation mode if a new time segment starts and the operation mode associated with the new time segment is different from the previous one. But as noted above, the mobile device may be triggered to update the operation mode by other conditions, e.g., when the user generates a new appointment in the calendar application or the mobile device is at a predefined location that requires an operation mode different from the operation mode associated with the current time segment. For example, the mobile device may measure the sound volume in the background and then determine whether or not to change the ringtone for an incoming call currently defined for a particular operation mode. In sum, by associating different operation modes with different time segments, the mobile device can operate in a more user-friendly fashion such that the mobile device automatically switches from one operation mode to another operation mode when the mobile device enters a new time segment that has a different operation mode than the current one in force. This approach can save the user of the mobile device a lot of time spent on configuring the mobile device to best fit his or her current schedule.

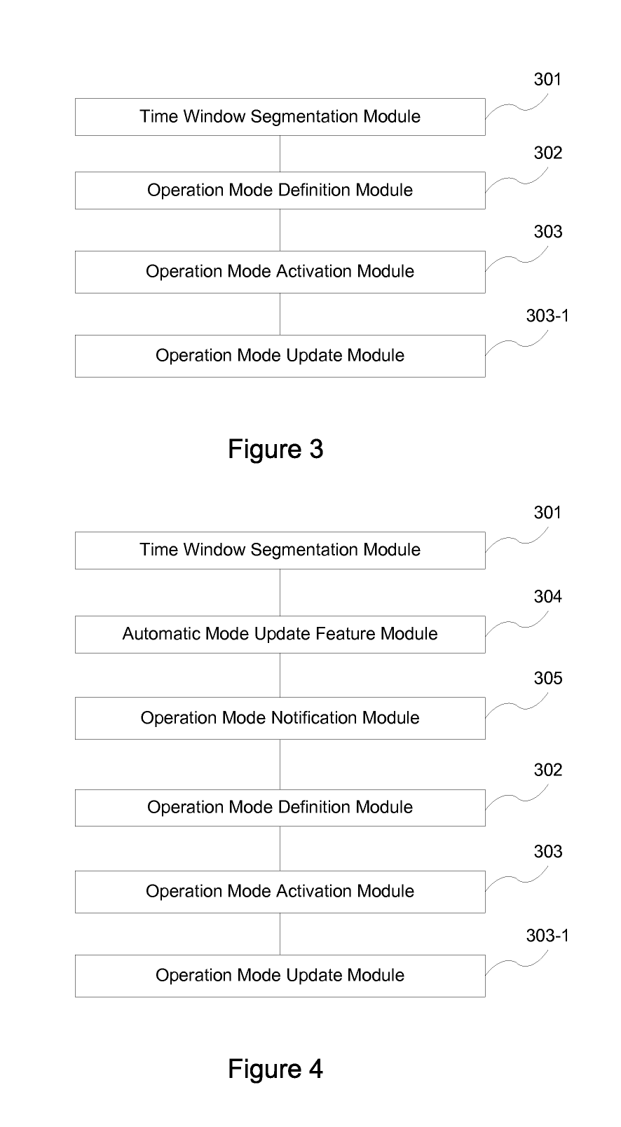

FIGS. 3-5 are block diagrams illustrative of a third embodiment of program modules in a mobile device for configuring the operation modes for the mobile device.

As shown in FIG. 3, the mobile device includes: a time window segmentation module 301 configured to divide a predefined time window into multiple time segments for a mobile device based on a user's schedule; an operation mode definition module 302 configured to define an operation mode and associated information (e.g., a list of tasks) for each time segment; and an operation mode activation module 303 configured to activate a corresponding operation mode on the mobile device upon detection of the start of a particular time segment. In some embodiments, the mobile device further includes an operation mode update module 303-1 configured to update the predefined operation mode for a particular time segment, e.g., in response to the generation of an appointment that at least partially overlaps with the time segment or if the mobile device is at a predefined location that is inconsistent with the instructions defined in the operation mode associated with the time segment. In this case, the operation mode update module 303-1 is invoked to update the predefined operation mode associated with the time segment. By doing so, the mobile device can operate in a manner more likely consistent with the user's experience and expectation.

In some embodiments shown in FIG. 4, the mobile device may further include an automatic mode update feature module 304 configured to determine whether the mobile device should automatically change its operation mode based on the transition from one time segment to another time segment. As noted above, this feature may be turned on/off by the user manually or by some predefined conditions. In some embodiments, the mobile device further includes an operation mode notification module 305 configured to notify the other modules whether the feature is on or not and, if on, what operation mode should be activated by the mobile device.

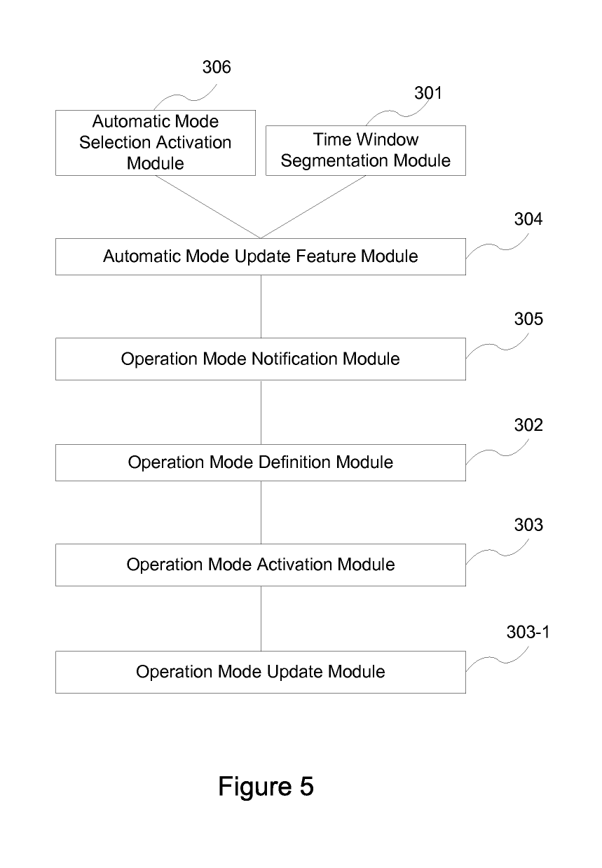

In some embodiments shown in FIG. 5, the mobile device further includes an automatic mode selection activation module 306 for determining whether there is a user instruction (e.g., by pressing a key of the mobile device) for turning on the automatic mode update feature or for determining whether a predefined condition has been satisfied for turning on the automatic mode update feature. In either case, the mobile device may turn on this feature and activate a particular operation mode based on, e.g., a determination of the current time segment.

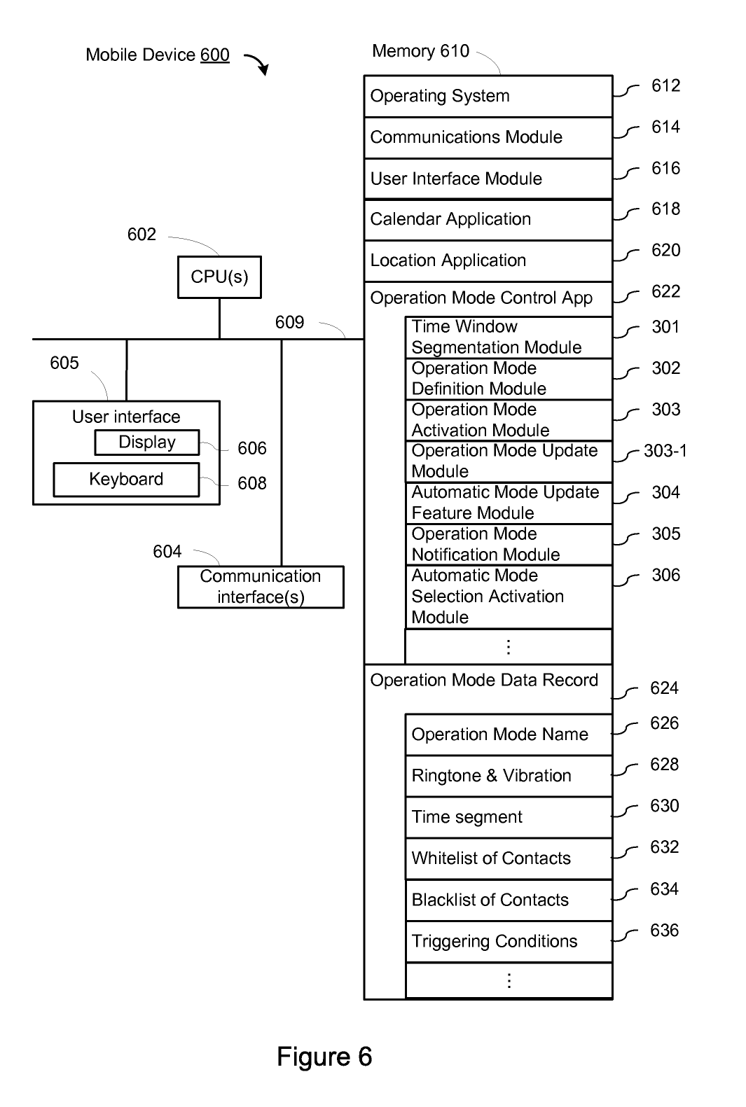

FIG. 6 is a block diagram of an exemplary mobile device in accordance with some embodiments. The exemplary mobile device 600 typically includes one or more processing units (CPU's) 602, one or more network or other communications interfaces 604, memory 610, and one or more communication buses 609 for interconnecting these components. The communication buses 609 may include circuitry (sometimes called a chipset) that interconnects and controls communications between system components. The mobile device 600 may include a user input device 605, for instance, a display 606 and a keyboard 608. Memory 610 may include high speed random access memory and may also include non-volatile or non-transitory memory, such as one or more magnetic disk storage devices. Memory 610 may include mass storage that is remotely located from the CPU's 602. In some embodiments, memory 610 stores the following programs, modules and data structures, or a subset or superset thereof:
an operating system 612 that includes procedures for handling various basic system services and for performing hardware dependent tasks;
a network communication module 614 that is used for connecting the mobile device 600 to a remote server (e.g., a website) or other computers via one or more communication networks (wired or wireless), such as the Internet, other wide area networks, local area networks, metropolitan area networks, and so on;
a user interface module 616 configured to receive user inputs through the user interface 605;
a calendar application 618 configured to manage the appointments for the user of the mobile device 600;
a location application 620 configured to provide a current location of the mobile device 600;
an operation mode control application 622, which further includes a time window segmentation module 301, an operation mode definition module 302, an operation mode activation module 303, an operation mode update module 303-1, an automatic mode update feature module 304, an operation mode notification module 305, and an automatic mode selection activation module 306 as described above in connection with FIGS. 3-5; and
one or more operation mode data records 624, each record including an operation mode name 626, ringtone and vibration information 628, time segment 630, a whitelist of contacts 632, a blacklist of contacts 634, and one or more triggering conditions 636 as described above in connection with FIGS. 1 and 2.

While particular embodiments are described above, it will be understood it is not intended to limit the invention to these particular embodiments. On the contrary, the invention includes alternatives, modifications and equivalents that are within the spirit and scope of the appended claims. Numerous specific details are set forth in order to provide a thorough understanding of the subject matter presented herein. But it will be apparent to one of ordinary skill in the art that the subject matter may be practiced without these specific details. In other instances, well-known methods, procedures, components, and circuits have not been described in detail so as not to unnecessarily obscure aspects of the embodiments.

The terminology used in the description of the invention herein is for the purpose of describing particular embodiments only and is not intended to be limiting of the invention. As used in the description of the invention and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, operations, elements, and/or components, but do not preclude the presence or addition of one or more other features, operations, elements, components, and/or groups thereof.

As used herein, the term “if” may be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” may be construed to mean “upon determining” or “in response to determining” or “in accordance with a determination” or “upon detecting” or “in response to detecting” that the stated condition precedent is true, depending on the context.

Although some of the various drawings illustrate a number of logical stages in a particular order, stages that are not order dependent may be reordered and other stages may be combined or broken out. While some reordering or other groupings are specifically mentioned, others will be obvious to those of ordinary skill in the art and so do not present an exhaustive list of alternatives. Moreover, it should be recognized that the stages could be implemented in hardware, firmware, software or any combination thereof.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated.

What is claimed is:

1. A computer-implemented method, comprising:
at a mobile device having one or more processors and memory storing programs executed by the one or more processors:
dividing a predefined time window into multiple time segments for the mobile device based on a user's schedule;
for each time segment, defining an operation mode and associated information for the mobile device, wherein the associated information includes a set of instructions for processing incoming calls or messages during the time segment; and
upon detection of the start of a particular time segment:
identifying a corresponding operation mode; and
activating the identified operation mode on the mobile device such that, in response to an incoming call or message, the mobile device performs a set of instructions associated with the operation mode.

2. The method of claim 1, wherein the associated information includes a whitelist of contacts and instructions for alerting the user of incoming calls or messages from the whitelist of contacts during the corresponding time segment.

3. The method of claim 1, wherein the associated information includes a blacklist of contacts and instructions for blocking incoming calls from the blacklist of contacts during the corresponding time segment.

4. The method of claim 1, wherein the associated information includes a set of triggering conditions and instructions for processing incoming calls or messages according to the set of triggering conditions during the corresponding time segment.

5. The method of claim 4, wherein the set of triggering conditions includes a determination of a current battery power level of the mobile device and the instructions include choosing a type of incoming call or message alert based on the current battery power level during the corresponding time segment.

6. The method of claim 1, further comprising:
querying a calendar application to determine whether the user has an appointment overlapping with the particular time segment;
if there is an overlapping appointment:
determining whether the appointment is consistent with the operation mode associated with the time segment; and
updating the set of instructions associated with the operation mode based on a determination of the appointment.

7. The method of claim 6, wherein, if the appointment is a meeting appointment, the set of instructions is updated to block incoming calls from people not found in a predefined whitelist of contacts.

8. The method of claim 6, wherein the determination of the appointment includes determining whether the appointment includes an identifier of a user different from the user of the mobile device or a description of the appointment includes at least one of a set of predefined keywords.

9. The method of claim 1, further comprising:
querying a location application to determine a current location of the mobile device; and
updating the set of instructions associated with the operation mode based on the current location of the mobile device.

10. The method of claim 9, wherein, if the current location of the mobile device is different from a predefined location associated with the operation mode, the set of instructions is updated for handling incoming calls or messages based on the current location of the mobile device.

11. A mobile device, comprising:
one or more processors;
memory; and
one or more program modules stored in the memory and configured for execution by the one or more processors, the one or more program modules including instructions for:
dividing a predefined time window into multiple time segments for the mobile device based on a user's schedule;
for each time segment, defining an operation mode and associated information for the mobile device, wherein the associated information includes a set of instructions for processing incoming calls or messages during the time segment; and
upon detection of the start of a particular time segment:
identifying a corresponding operation mode; and
activating the identified operation mode on the mobile device such that, in response to an incoming call or message, the mobile device performs a set of instructions associated with the operation mode.

12. The mobile device of claim 11, wherein the associated information includes a whitelist of contacts and instructions for alerting the user of incoming calls or messages from the whitelist of contacts during the corresponding time segment.

13. The mobile device of claim 11, wherein the associated information includes a blacklist of contacts and instructions for blocking incoming calls from the blacklist of contacts during the corresponding time segment.

14. The mobile device of claim 11, wherein the associated information includes a set of triggering conditions and instructions for processing incoming calls or messages according to the set of triggering conditions during the corresponding time segment.

15. The mobile device of claim 14, wherein the set of triggering conditions includes a determination of a current battery power level of the mobile device and the instructions include choosing a type of incoming call or message alert based on the current battery power level during the corresponding time segment.

16. The mobile device of claim 11, wherein the one or more program modules further include instructions for:
querying a calendar application to determine whether the user has an appointment overlapping with the particular time segment;
if there is an overlapping appointment:
determining whether the appointment is consistent with the operation mode associated with the time segment; and
updating the set of instructions associated with the operation mode based on a determination of the appointment.

17. The mobile device of claim 11, wherein the one or more program modules further include instructions for:
querying a location application to determine a current location of the mobile device; and
updating the set of instructions associated with the operation mode based on the current location of the mobile device.

18. A non-transitory computer readable storage medium having stored therein one or more instructions, which, when executed by a mobile device, cause the mobile device to:
divide a predefined time window into multiple time segments for the mobile device based on a user's schedule;
for each time segment, define an operation mode and associated information for the mobile device, wherein the associated information includes a set of instructions for processing incoming calls or messages during the time segment; and
upon detection of the start of a particular time segment:
identify a corresponding operation mode; and
activate the identified operation mode on the mobile device such that, in response to an incoming call or message, the mobile device performs a set of instructions associated with the operation mode.

19. The non-transitory computer readable storage medium of claim 18, wherein the one or more instructions further include instructions for:
querying a calendar application to determine whether the user has an appointment overlapping with the particular time segment;
if there is an overlapping appointment:
determining whether the appointment is consistent with the operation mode associated with the time segment; and
updating the set of instructions associated with the operation mode based on a determination of the appointment.

20. The non-transitory computer readable storage medium of claim 18, wherein the one or more instructions further include instructions for:
querying a location application to determine a current location of the mobile device; and
updating the set of instructions associated with the operation mode based on the current location of the mobile device.
